(19) United States
(12) Patent Application Publication
(10) Pub. No.: US 2021/0343056 A1
(43) Pub. Date: Nov. 4, 2021

(54) ELECTRONIC BOOK MANUFACTURING METHOD AND COMPUTER PROGRAM THEREFOR

(71) Applicants: Jong Han PARK, Goyang-si, Gyeonggi-do (KR); PUBPLE CO., LTD, Goyang-si, Gyeonggi-do (KR)

(72) Inventor: Jong Han PARK, Goyang-si (KR)

(21) Appl. No.: 17/271,386

(22) PCT Filed: Aug. 30, 2018
(86) PCT No.: PCT/KR2018/010073

§ 371 Date: Feb. 25, 2021

(51) Int. Cl. G06T 11/60; G06F 16/56; G06F 16/51; G06F 40/106

(52) U.S. Cl. CPC G06T 11/60; G06F 40/106; G06F 16/51; G06F 16/56

(57) ABSTRACT

The present embodiment relates to a method for easier production of e-books with high text legibility, for minimizing the cost and labor required in service of the e-book-related content, and for reducing file size and increasing speed by eliminating unnecessary data in the production process, and to a computer program for the method.

### TECHNICAL FIELD

The present embodiments relate to a method for producing an e-book and a computer program therefor. More specifically, the present embodiments relate to a method for optimizing a vector graphic text which is contour-processed when producing a vector graphics-based e-book, and to a computer program therefor.

### BACKGROUND

The following description merely provides background information related to embodiments according to the present invention, and does not constitute prior art.

Recently, the awareness of education is changing as an educational environment and an educational policy of the government are changed. Various attempts have been made to support this change. Among these attempts, an e-book refers to a digital book which records audiovisual information such as characters, images and videos on an electronic media and may be used like conventional books. The e-book has drawn attention as a new educational service model as development and penetration of e-learning content are boomed.

An ePUB (Electronic PUBlication) is an e-book format standard developed by the IDPF (International Digital Publishing Forum), and is currently becoming a de facto standard in an e-book market. In line with this trend, most publishers are currently producing e-books pursuant to the EPUB format. However, despite the booming ePUB market, there remain still lots of difficulties for publishers who have been publishing traditional books or for individuals who have content to publish as ePUB e-books. For this reason, the publishers and individuals are making the ePUB e-books using an e-book authoring tool which is distributed free from distributors. Such a conventional e-book authoring tool, however, still has a problem that it is difficult for users to use, which acts as a barrier to the activation of the ePUB market.

Therefore, there is a need for a new type of e-book producing method for easier production of e-books with high text legibility, for minimizing cost and labor required therefor, and for reducing file size and increasing speed by eliminating unnecessary data in the production process.

### SUMMARY

### Technical Problem

It is one object of the present embodiment to provide an e-book producing method for easier production of e-books with high text legibility, for minimizing the cost and labor required in service of the e-book-related content, and for reducing file size and increasing speed by eliminating unnecessary data in the production process, and to provide a computer program for the method.

### Technical Solution

The present embodiment provides an e-book producing program stored in a recording medium. The e-book producing program is configured to be in combination with hardware to perform an e-book producing method. The method comprises receiving an original content including a text information, extracting the text information from the original content and converting the text information into a vector image information by reconstructing a format of the text information into an vector image format, selecting an identical vector image information whose data values corresponding to the text information are identical to each other from among the vector image information based on vector graphic data value calculated in the process of converting of the text information into the vector image information, and reconstructing a data structure in which the identical vector image information is stored, based on the vector graphic data value.

Another aspect of the present disclosure provides an e-book producing device comprising an input unit, a vector image generating unit, a selecting unit, and a data processing unit. The input unit configured to receive an original content including a text information. The vector image generating unit is configured to extract the text information from the original content and to convert the text information into a vector image information by reconstructing a format of the text information into a vector image format. The selecting unit is configured to select an identical vector image information whose data values corresponding to the text information are identical to each other from among the vector image information based on vector graphic data value calculated in the process of converting of the text information into the vector image information. The data processing unit is configured to reconstruct a data structure in which the identical vector image information is stored, based on the vector graphic data value.

### Advantageous Effects

As described above, according to the present embodiment, the identical text information displayed on a screen is provided by converting it into a vector graphic of the reference type in the production of an e-book, thereby minimizing a total capacity of an e-book file and providing content having a high readability compared to a conventional one.

Further, according to the present embodiment, the text information is provided by covering it into the vector-based graphic, thereby preventing an occurrence of an expression error due to a difference between font rendering methods supported by each e-book viewer device, in advance.

Further, according to the present embodiment, the unnecessary data is reduced by gathering the identical data with reference type in the production of an e-book, thereby improving file size and speed.

### BRIEF DESCRIPTION OF THE DRAWINGS

FIG. 1 is a schematic block diagram of an e-book service system in accordance with an embodiment.

FIG. 2 is a schematic block diagram of an e-book producing device in accordance with an embodiment.

FIG. 3 is schematic block diagram of a selecting unit in accordance with an embodiment.

FIG. 4 is schematic block diagram of a data processing unit in accordance with an embodiment.

FIG. 5 is flowchart for illustrating a method for data optimization when producing an e-book in accordance with an embodiment.

FIG. 6 illustrates a data optimization process in producing an e-book in accordance with an embodiment.

FIGS. 7a and 7b are example diagrams illustrating data structure of vector image information based on a method for data optimization in accordance with an embodiment.

### DETAILED DESCRIPTION

Hereinafter, the present embodiments will be described in detail with reference to the accompanying drawings.

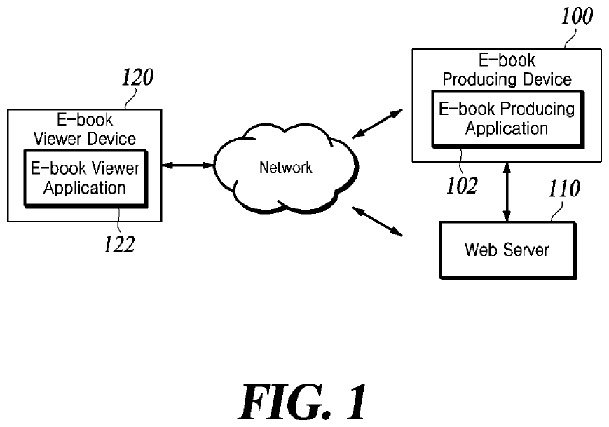

FIG. 1 is a schematic block diagram of an e-book service system in accordance with an embodiment.

As shown in FIG. 1, an e-book service system according to the present embodiment includes an e-book producing device 100, a web server 110, and an e-book viewer device 120.

The e-book producing device 100 is a device that receives an original content including text information and image information from the web server 110 or a user, and automatically generates and provides an e-book-related content file based on the received original content.

The e-book producing device 100 refers to a terminal capable of transmitting and receiving various data via a network based on a key operation of the user. The e-book producing device 100 may be any one of a tablet PC, a laptop, a personal computer (PC), a smart phone, a personal digital assistant (PDA), a mobile communication terminal, and the like.

The e-book producing device 100 according to the present embodiment may be equipped with an e-book producing application 102 for use in processing data on the e-book-related content. The e-book producing device 100 may execute the e-book producing application 102 in response to a user's operation or command, and provide the data process for the e-book-related content by using the e-book producing application 102.

Hereinafter, an operation of the e-book producing device 100 for providing the data process for the e-book-related content will be described. When the installed e-book producing application 102 is executed, the e-book producing device 100 parses the received original content to extract meta information for text information and image information included in the original content, and generates collected data based on the extracted meta information. Herewith, layout information including a location coordinate value for each of the text information and the image information, and attribute information including a data value (text content) corresponding to the text information, may be collected as the meta information. According to an embodiment, at least one of font information, location information, size information, slant information, and color information for the text information may be additionally collected as the attribute information for the text information.

In accordance with the present embodiment, the e-book producing device 100 converts text information requiring high readability into vector-based graphics. Herein, in the process of converting a format of the text information into a vector image format, loss of data from the original text information may occur. Therefore, there may exist a problem that an error occurs as the e-book viewer device fail to correctly recognize the text information when performing a function related to the text information. Prior to a process of constructing vector imaging from text information, therefore, the e-book producing device 100 according to the present embodiment extracts the meta information for the text information and the image information included in the original content, and generates and provides the collected data based on the extracted meta information. Such collected data may become a substitute data for replacing the loss data lost in the process of constructing vector image from the text information.

The e-book producing device 100 extracts the text information from the original content and then converts the text information into the vector image information. The vector image information is an image generated by drawing a contour using dots and lines which are vectors and by filling inside the contour. The vector image information refers to an image format that can maintain the same form as the original even when zoomed in or out. This vector image information can always provide a clear image regardless of the zoom in/out of the original because the contour is composed of connected lines.

The e-book producing device 100 according to the present embodiment converts the text information for which a readability is critical into the vector-based graphics in the production of the e-book, thereby providing content having a high readability compared to the conventional counterpart. Further, the e-book producing device 100 reconstructs the format of the text information into the vector image format, and provides the reconstructed text information, and the text information can be output on a screen free from distortion, and hereby the expression error in the text information that may be caused by different font rendering methods supported by each e-book viewer device can be prevented.

In the process of converting the text information into the vector image information, the e-book producing device 100 according to the present embodiment generates text information in a SVG (Scalable Vector Graphics) file format which comprises vector graphic value and matrix information. Herein, the vector graphic value refers to information that represents the character shape of text information as vector-based data. The matrix information may include matrix coordinate, scale, and style information (ex. color and thickness etc.) of the vector image information.

In the vector image information converted from identical texts appearing in the same page, each of the vector image information has the same vector graphic data value, but has different matrix information. In the conventional counterpart, however, unnecessary data are produced because the same vector graphic data value should be repeatedly generated for each character in order to represent identical texts as vector graphic file format, thereby increasing the file size.

In light of the above, in the process of converting the text information into the vector image information, the e-book producing device 100 according to the present embodiment reconstructs the data structure in which the vector graphic file format is stored, based on the vector graphic data value, for identical vector image information of which the data value corresponding to the text information is identical to that of other vector image information, and stores the reconstructed data. Accordingly, the e-book producing device 100 allows the same vector graphics data value to be rendered simultaneously at each location corresponding to the matrix information for the identical vector image information, when later rendering the vector image information on screen. This has an advantage of reducing the file size and increasing the speed by eliminating the production of unnecessary data.

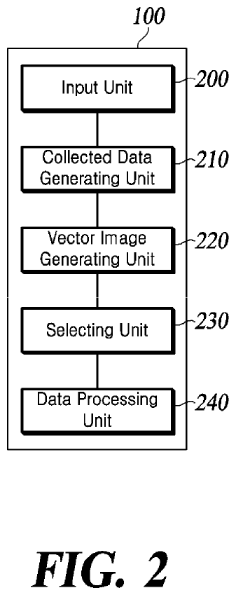

A detailed method for the e-book producing device 100 according to the present embodiment to optimize the data of the vector image information will be described with FIG. 2.

The e-book producing device 100 extracts the image information from the original content, and stores the extracted image information in a preset image format. Herein, the image information extracted by the e-book producing device 100 is preferably image information corresponding to a background image in the content, but is not limited thereto.

The e-book producing device 100 according to the present embodiment stores the extracted image information in a bitmap image format. The bitmap image format uses a method for storing and reconstructing an image by using an array of pixel data constituting the whole image, which has an advantage of not overburdening the system regardless of complexity or definition of fine the image. That is, the e-book producing device 100 according to the present embodiment stores the image information extracted from the original content in the bitmap image format, and therefore is able to minimize the total size of a resultant e-book file.

The e-book producing device 100 generates the e-book file in a preset format based on the collected data, the vector image information, and the image information. In accordance with the present embodiment, the e-book producing device 100 preferably generates the e-book file in the ePUB (Electronic PUBlication) format based on the collected data, the vector image information, and the image information, but is not limited thereto.

The e-book producing application 102 may be implemented to operate independently in a form having a separate software function or hardware function performed by the e-book producing device 100 or in a form interworking with the separate software function or hardware function performed by the e-book producing device 100.

The web server 110 provides the original content used for generating the e-book file to the e-book producing device 100. Herewith, the original content provided from the web server 110 is preferably a document produced in an EPS (Encapsulated PostScript) format or a PDF (Portable Document Format) format, but is not limited thereto.

The e-book viewer device 120 receives the e-book file from the web server 110 or the e-book producing device 100 to allow the user to view content of the received e-book file.

The e-book viewer device 120 according to the present embodiment may be equipped with an e-book viewer application 122 to provide a viewer function for the e-book-related content. The e-book viewer device 120 may execute the e-book viewer application 122 in response to a user's operation or command, and provides the viewer function for the e-book-related content via the e-book viewer application 122.

Hereinafter, an operation for which the e-book viewer device 120 provides the viewer function for the e-book-related content will be described. When the installed e-book viewer application 122 is executed, the e-book viewer device 120 parses the received e-book file and extracts the collected data, the vector image information, and the image information included in the e-book file.

The e-book viewer device 120 extracts the layout information from the collected data and displays the vector image information at a location corresponding to a location coordinate value of the text information included in the extracted layout information. In accordance with the present embodiment, the e-book producing device 100 converts the text information for which the readability is critical into the vector-based graphics in the production of the e-book and provides the vector-based graphics. In other words, the e-book viewer device 120 displays and provides the vector image information corresponding to the text information on a location where the original text information is displayed based on the layout information included in the collected data.

The e-book viewer device 120 displays the image information on a location corresponding to a location coordinate value of the image information included in the layout information.

The e-book viewer device 120 further provides various additional functions related to the text information displayed as the vector image information by using the collected data.

The e-book viewer application 122 may be implemented to operate independently in a form having a separate software function or hardware function performed by the e-book viewer device 120 or in a form interworking with the separate software function or hardware function performed by the e-book viewer device 120.

FIG. 2 is a schematic block diagram of an e-book producing device in accordance with an embodiment.

FIG. 2 is a schematic block diagram of the e-book producing device 100 according to the present embodiment, which may be implemented as a separate stand-alone device in which hardware of the terminal and the software of the e-book producing application 102 are combined. For example, functional modules of the e-book producing device 100 shown in FIG. 2 may be operated when the e-book producing application 102 installed in the e-book producing device 100 is executed.

As shown in FIG. 2, the e-book producing device 100 according to the present embodiment includes an input unit 200, a collected data generating unit 210, a vector image generating unit 220, a selecting unit 230, and a data processing unit 240. The elements included in the e-book producing device 100 according to at least one embodiment is not limited thereto. In other words, the example configuration of FIG. 2 is illustrative of the e-book producing device 100 according to at least one embodiment with elements for the function of data optimization among elements of the e-book producing device 100, and it should be appreciated that the e-book producing device 100 may have configurations of more or fewer elements or other elements than those illustrated, to implement other functions.

The input unit 200 receives the original content used for producing the e-book.

In accordance with the present embodiment, the input unit 200 may receive the original content from the web server 110 or the user. To this end, the input unit 200 is equipped with communication interface for communications with an external device, a user interface for receiving a selection command from the user, and the like.

Further, the original content inputted via the input unit 200 may comprise the text information and the image information, and be preferably a content file produced in an EPS format or a PDF format, but is not limited thereto.

The collected data generating unit 210 parses the original content, then extracts the meta information for the text information and the image information included in the original content, and generates the collected data based on the extracted meta information.

The layout information including a location coordinate value for each of the text information and the image information, and the attribute information including a data value (text content) corresponding to the text information may be collected as the meta information. According to an embodiment, at least one of the font information, the size information, and the color information for the text information may be additionally collected as the attribute information for the text information.

Such collected data may be used as the substitute data for replacing the loss data lost in the process of constructing image from the text information, and may be used as a reference data in the process of selecting the identical vector image information.

The vector image generating unit 220 extracts the text information from the original content, and then converts the text information into the vector image information.

The vector image generating unit 220 outlines a contour of a character in the text information to calculate coordinates and numerical information on a plurality of lines constituting a shape of the text information. The vector image generating unit 220 generates the text information in a SCV (Scalable Vector Graphics) format, which comprises vector graphic value and matrix information, based on the calculated coordinate and numerical information

The selecting unit 230 selects identical vector image information of which data values corresponding to the text information are identical to each other, from among the vector image information generated by the vector image generating unit 220, based on the vector graphic value calculated in the process of imaging of the text information. Herein, the identical vector image information refers to a vector image information generated for identical texts with the same content and different locations on the same page. For example, the vector image information generated for the character “ [symbol] ” on a page may be the identical vector image information.

In accordance with the present embodiment, the selecting unit 230 selects the identical vector image information by additionally utilizing part or all of the collected data generated by collected data generating unit 210 and the matrix information calculated by the vector image generating unit 210, in the process of selecting the identical vector image information.

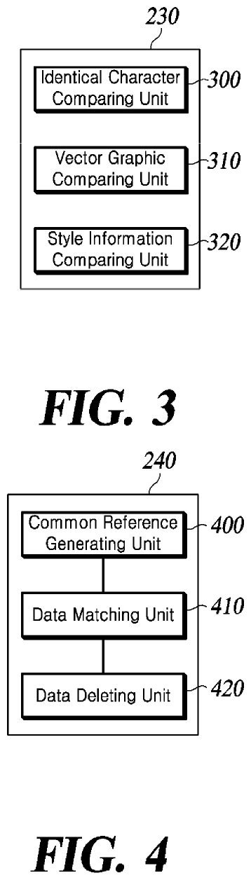

With reference to FIG. 3, in accordance with the present embodiment, the selecting unit 230 may be configured to include an identical character comparing unit 300, a vector graphic comparing unit 310, and a style information comparing unit 320.

The identical character comparing unit 300 performs selection of the identical vector image information by using the collected data generated by the collected data generating unit 210 as a reference data.

The identical character comparing unit 300 selects vector image information of which data values of text information corresponding to each of the vector image information are identical to each other as the identical vector image information based on the attribute information for the text information included in the collected data.

The vector graphic comparing unit 310 performs selection of the identical vector image information using the vector graphic data value calculated in the process of imagining of the text information as a reference data.

The vector graphic comparing unit 310 compares the vector graphic data values corresponding to each of the vector image information, and selects the vector image information having identical vector graphic data value as the identical vector image information.

The style information comparing unit 320 performs selection of the identical vector image information using the matrix information calculated in the process of imaging of the text information. Further, a comparison result of the style information comparing unit 320 may be used as supplementary information for a comparison result of the identical character comparing unit 300 and a comparison result of the vector graphic comparing unit 310.

The style information comparing unit 320 may compare style information included in the matrix information for each of the vector image information, and select vector graphic information of which style information is identical to that of other vector graphic information as the identical vector image information according to the comparison result.

The data processing unit 240 performs reconstruction of data structure in which the identical vector image information selected by the selecting unit 230 is stored, based on the vector graphic data value.

In accordance with the present embodiment, the data processing unit 240 reconstructs data structure of data in which the vector graphic file format is stored, based on the vector graphic data value for vector image information of which the data value corresponding to the text information is identical to that of other vector image information, and stores the reconstructed data.

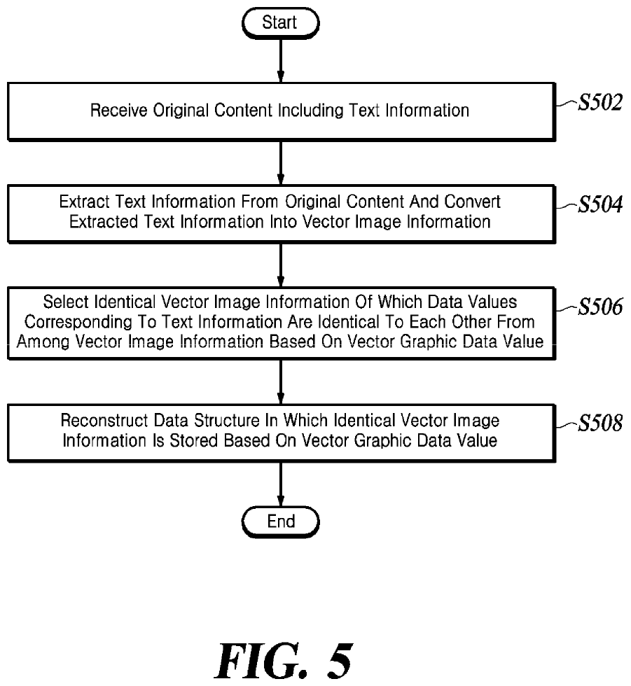

Referencing with FIG. 4, the data processing unit 240 according to the present embodiment may include a common reference generating unit 400, a data matching unit 410, and a data deleting unit 420.

The common reference generating unit 400 generates the vector graphic data value corresponding to each of the identical vector image information as a common reference data. The common reference generating unit 400 generates the vector image data, which is common value between the identical vector image information, as a common information.

The data matching unit 410 performs matching of each matrix information corresponding to each of the identical vector image information on the common reference data, and stores the matrix information. For example, the data matching unit 410 may sequentially perform matching of each matrix information corresponding to each identical vector image information as a child node of the common reference data, and store the matrix information.

The data deleting unit 420 performs deletion of redundant or unnecessary data, produced by the reconstruction process for the identical vector image information. For example, the data deleting unit 420 may delete the vector graphic data value selected as the common reference data for each identical vector image information from among pre-stored vector graphic file formats, prior to the process of the reconstruction of the data structure.

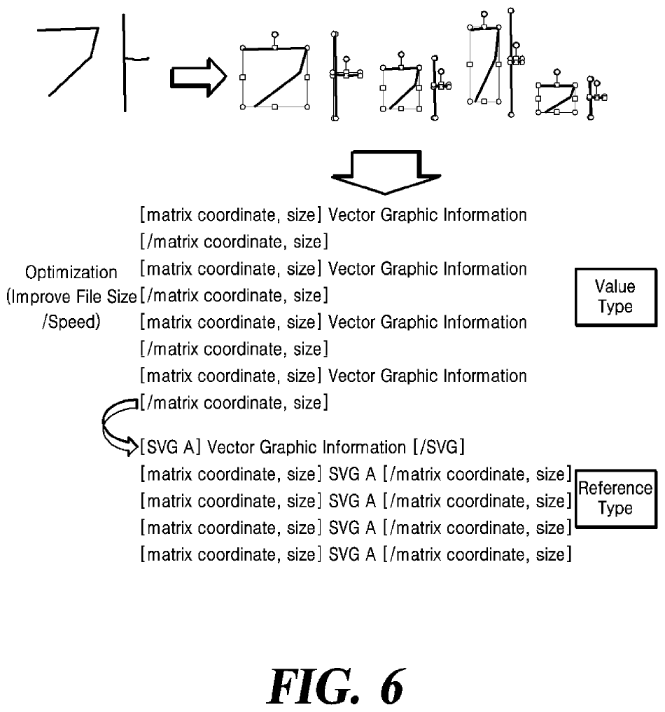

FIG. 5 is flowchart for illustrating a method for data optimization in producing an e-book in accordance with an embodiment.

The e-book producing device 100 receives the original content including the text information (S502). At step S502, the e-book producing device 100 may extract the meta information on the text information from the original content to generate the collected data.

The e-book producing device 100 extracts the text information from the original content received at step S502 and converts the extracted text information into the vector image information (S504). In step S504, the e-book producing device 100 performs outline process to generate the contour of the character in the text information, calculates coordinates and numeral information on a plurality of lines constituting the shape of the text information, and then convert the format of the text information into the image format based on the calculated coordinates and numeral information.

The e-book producing device 100 selects the identical vector image information of which data values corresponding to the text information are identical to each other from among the vector image information based on the vector graphic data values calculated in the conversion process of step S504 (S506). In step S506, the e-book producing device 100 may additionally utilize part or all of the collected data generated at step S502 and the matrix information calculated at step S504 to select the identical vector image information.

The e-book producing device 100 reconstructs the structure of data, in which the identical vector image information selected in S506 is stored, based on the vector graphic data value, and produces the reconstructed data (S508). In step S508, the e-book producing device 100 generates a common vector graphic data value between the identical vector image information as vector graphic data of a reference type, matches each of the matrix information according to each of the identical vector image information on the vector graphic data, and then stores them.

Herein, the operations of steps S502 to S508 correspond to the operations of the respective components of the e-book producing device 100 described above, and therefore a detailed description will be omitted.

Each step is shown to be sequentially executed in FIG. 5, but is not limited thereto. The procedure described in FIG. 5 may be modified by changing the order of the steps or by executing the one or more steps in parallel. Therefore, FIG. 5 is not limited to the shown time-series order.

Further, the e-book producing method described in FIG. 5 may be implemented in a program, and recorded in a recording medium (CD-ROM, RAM, ROM, memory card, Hard disk, magneto-optical disk, storage device, etc.).

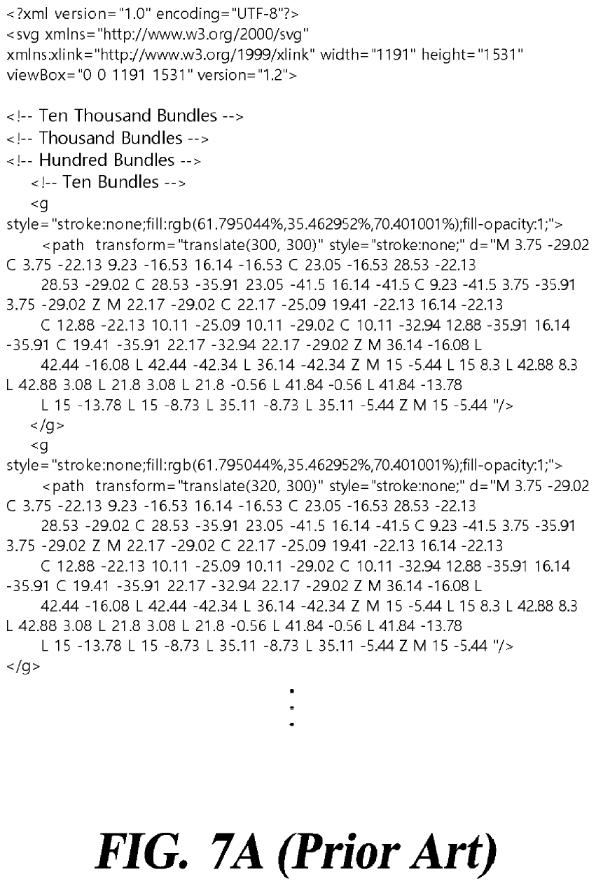

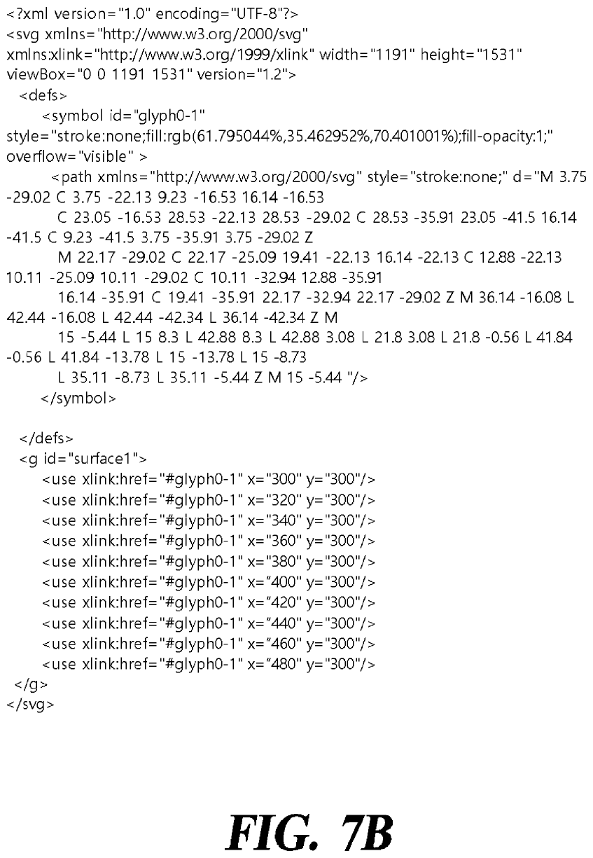

FIG. 6 illustrates a data optimization process in the production of an e-book in accordance with an embodiment, and FIGS. 7a and 7b are example diagrams illustrating data structure of vector image information based on a method for data optimization in accordance with an embodiment.

As shown in FIG. 6, the e-book producing device 100 according to the present embodiment converts the text information for which a readability is critical into vector-based graphics, thereby providing content having a high readability compared to the conventional counterpart.

The e-book producing device 100 convert the format of text information into a vector graphic file format which comprises vector graphic value and matrix information, via the process of converting the text information into the vector image information. In the vector image information converted from identical texts appearing in the same page, each of the vector image information has the same vector graphic data value, but has different matrix information.

Referencing with FIG. 7a, according to a conventional value type, unnecessary data are produced because the same vector graphic data value should be repeatedly generated for each character in order to represent the format of text as vector graphic file format, thereby increasing the file size.

On the other hand, in accordance with the reference type according to the present embodiment, the data structure in which the vector graphic file format of the identical vector image information is stored is reconstructed and stored based on the vector graphic data value, in the process of converting the text information the into vector image information, as shown in FIG. 7b. Herein, the identical vector image information refers to vector image information of which the data value corresponding to the text information is identical to that of other vector image information.

In accordance with the data optimization according to the present embodiment, many aspects such as file size, loading speed, CPU occupancy, data structure, and the like are improved compared to the conventional value type.

Hereinabove, although the present disclosure has been described with reference to exemplary embodiments, the present disclosure is not limited thereto, but may be variously modified and altered by those skilled in the art to which the present disclosure pertains without departing from the spirit and scope of the present disclosure. Therefore, the present embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

### REFERENCE NUMERALS

| | |
|---|---|
| 100: e-book producing device | 102: e-book producing application |
| 110: web server | 120: e-book viewer device |
| 122: e-book viewer application | 200: input unit |
| 210: collected data generating unit | 220: vector image generating unit |
| 230: selecting unit | 240: data processing unit |
| 300: identical character comparing | 310: vector graphic comparing unit |
| unit | |
| 320: style information comparing unit | |
| 400: common reference generating | |
| unit | |
| 410: data matching unit | 420: data deleting unit |

What is claimed is:

1. An e-book producing program stored in a recording medium, wherein the e-book producing program is configured to be in combination with hardware to perform an e-book producing method, the method comprising:
receiving an original content including a text information;
extracting the text information from the original content and converting the text information into a vector image information by reconstructing a format of the text information into a vector image format;
selecting an identical vector image information whose data values corresponding to the text information being identical to each other from among the vector image information based on a vector graphic data value calculated in the process of converting the text information into the vector image information; and
reconstructing a data structure in which the identical vector image information is stored, based on the vector graphic data value.

2. The e-book producing program of claim 1, wherein the converting the text information into the vector image information includes:
generating a contour line of a character included in the text information and calculating coordinates and numerical information on a plurality of lines constituting a shape of the text information; and
reconstructing the format of the text information into the vector image format based on calculated coordinates and the numeral information.

3. The e-book producing program of claim 2, wherein the reconstructing the format of the text information into the vector image format includes:
storing the text information in a SVG (Scalable Vector Graphics) file format which have a vector graphic value and a matrix information.

4. The e-book producing program of claim 1, wherein the selecting the identical vector image information includes:
comparing vector graphic values corresponding to each of the vector image information and selecting the vector image information having identical vector graphic data value to each other as the identical vector image information.

5. The e-book producing program of claim 4, the method further comprising:
extracting a meta information about the text information from the original content and generating a collected data,
wherein the selecting the identical vector image information includes:
selecting the identical vector image information by additionally using part or all of the collected data and the matrix information corresponding to each of the vector image information.

6. The e-book producing program of claim 5, wherein the selecting the identical vector image information includes:
selecting the vector image information whose the data values and a style information corresponding to the text information are identical to each other as the identical vector image information based on the collected data and the matrix information corresponding to each of the vector image information.

7. The e-book producing program of claim 1, wherein the reconstructing the data structure includes:
generating the vector graphic data value corresponding to each of the identical vector image information as a common reference data; and
matching each matrix information corresponding to each of the identical vector image information on the common reference data and storing the matching result.

8. The e-book producing program of claim 7, wherein the reconstructing the data structure further includes:
deleting the vector graphic data value selected as the common reference data for each of the identical vector image.

9. An e-book producing device comprising:
an input unit configured to receive an original content including a text information;
a vector image generating unit configured to extract the text information from the original content and to convert the text information into a vector image information by reconstructing a format of the text information into a vector image format;
a selecting unit configured to select an identical vector image information whose data values corresponding to the text information are identical to each other from among the vector image information based on vector graphic data value calculated in the process of converting of the text information into the vector image information; and
a data processing unit configured to reconstruct a data structure in which the identical vector image information is stored, based on the vector graphic data value.
